(19) United States
(12) Patent Application Publication
(10) Pub. No.: US 2010/0218884 A1
(43) Pub. Date: Sep. 2, 2010

(54) Method of manufacture for reinforcing inner tubes within high pressure reinforced hose

(75) Inventor: Gardner T. Baldwin, Houston, TX (US)

Correspondence Address: ALWORTH LAW & ENGINEERING, 505 CUMBERLAND ROAD, TYLER, TX, 75703-9324, US

(73) Assignee: George Myer Company, Inc., Houston, TX (US)

(21) Appl. No.: 12/658,995

(22) Filed: Feb. 16, 2010

Related U.S. Application Data
(60) Provisional application No. 61/208,941, filed on Mar. 2, 2009.

(51) Int. Cl. F16L 11/24; F16L 11/04; B29C 63/14

(52) U.S. Cl. 156/188; 138/129; 138/137; 138/125

(57) ABSTRACT

A Method of Manufacture for reinforcing the inner tube of reinforced high pressure flexible hose. The method essentially places carbon fibre filaments running axially (longitudinally) with the hose in the first several layers of the built-up inner tube. The filaments are placed as near as possible to the inner wall of the inner tube so that the fibres do not interfere with the overall bending radius of the reinforced high pressure flexible hose. The strengthened inner tube is far more capable of meeting the new API (October 2006) temperature and flexibility (pulsation) standards for oil field equipment reinforced rubber hose.

This application claims the benefit of priority of U.S. Provisional Application Ser. No. 61/208,941 filed on Mar. 2, 2009.

### TECHNICAL FIELD OF THE INVENTION

The present invention relates generally to the reinforced rubber hose industry and in particular to a method of manufacture that reinforces the inner tube of large diameter high pressure flexible reinforced rubber hose utilizing swaged hose couplings for the energy, marine, petrochemical and like industries.

### BACKGROUND OF THE INVENTION

High-pressure rubber hose is used in many instances in industry but particularly in the mining, construction, energy, marine and petrochemical industries. Flexible rubber hose is used to transfer fluids under various pressures and temperature between two points, one or both of which, may move relative to each other or to another fixed point in space. Piping at the two points is generally metal (or some other form of fixed conduit) and the flexible hose must attach to the piping at both ends. This requires a coupling on each end of the hose.

In the drilling industry, a flexible rubber hose runs between the pump piping system on the rig and the kelly that is coupled to the rotating drill string. The pump system forces drilling fluid down the center of the drill pipe, and back through the wellbore, in order to flush cuttings from the wellbore (plus providing wellbore stability, etc.). In this instance, the flexible hose is subjected to high pressures. The high pressure is required to both transfer drilling fluid into the wellbore and overcome static return head pressures—the deeper the wellbore, the higher the pressure.

The rotary drilling hose is subject to further stress in that it hangs down within the derrick supported at either end by the metal coupling on the hose and the fact that the kelly is moved up and down literally thousands of times during the drilling operation. This means that the hose is subject to stress at the metal coupling (in addition to being subject to stress throughout its length). Thus, a highly reliable bonding between the hose and the coupling is required for protection of personnel and equipment. If the hose breaks loose from the coupling, it could easily fall and cause severe damage on the drill floor of the rig. In a similar manner, if the hose breaks, circulation may be lost resulting in a well blowout situation.

In order to obtain a high-pressure flexible rubber hose (the term rubber is used generally and does not specifically mean natural occurring rubber gum), a hose manufacturer incorporates a reinforcing material. Thus, the hose will consist of an inside sealing membrane—the fluid tight element, an inner rubber element, a reinforcing element, an outer rubber element, and finally some sort of abrasive resistant covering. The reinforcing element can be polyester or similar organic material, a high technology material or metal (steel) generally in the form of wire or cable. The reinforcement generally is used in multiple layers called “plys” And usually made of steel.

There is a plurality of types of reinforcing employed by the hose manufacturer that is set down in even layers—i.e., 2 layers, 4 layers, 6 layers, etc., single wire or cable wire, and grading systems are used to specify burst pressures for hose. For example, in the rotary drilling industry, grade C hose has a minimum burst pressure of 10,000 psi, grade D hose has a minimum burst pressure of 12,500 psi and grade E hose has a minimum (guaranteed) burst pressure of 18,750 psi. Grade C and D hose are 2 ply hose, although there is some 4 ply D hose. Most grade E hose is 4 ply. Swage end connectors are currently available for two ply hose and therefore the burst pressure range for C and D hoses is covered by the current art.

Generally a hose manufacturer manufactures flexible hoses to specific order by the purchaser who specifies length, diameter, pressure, service ratings and required end connections. These flexible hoses are generally referred to as a “hose assembly with end connectors” or “a built-up hose assembly.” This term is used throughout the industry.

In a built up hose assembly with end connections, the manufacturer, during the course of manufacturing terminates the rubber hose into a metal fitting (the end connector) as specified by the purchaser. Thus, the manufacturer would make the inner rubber membrane (1^{st} Carcass) and its associated inner seal layer (tube) and terminate this assembly in the end connector. The manufacturer would then add the wire reinforcement, as needed, terminating each reinforcing wire (or cable) in the end connector. Two techniques are typically employed by hose manufacturers for terminating the wire reinforcing in or on the end connector itself but are beyond the scope of this discussion. Finally the outer rubber layer (2^{nd} Carcass) and outer cover (cover) would be formed about the reinforcing wire or cable and the overall product vulcanized to achieve a cohesive product.

It takes time to manufacture a hose assembly with end connections and often such a hose is needed almost immediately by industry. In order to service this demand a separate industry termed the local market distributor has evolved. The local market distributor keeps bulk reinforced hose—hose without connectors—in inventory. The purchaser would specify the hose requirements—diameter, length, pressure rating and end connectors—to the local market distributor. The local market distributor then takes bulk reinforced rubber hose from inventory, cuts the hose to required length, and places a coupling on each end of the hose. Bulk hose is available in varying lengths from a hose manufacturer, and the actual bulk length (between 90 and 110 feet) will depend on the mandrel used by the manufacturer.

The resulting hose is called a SWAGED or CRIMPED HOSE, depending on the method used to “place” the end connector onto the hose, where the term “place” is being used to include both swaging and/or crimping operations. It should be noted that swaging and crimping accomplish similar end results.

The current state of the art in swaged (or crimped) connectors has evolved to using an outer ferrule with lands (internal ridges) that are compressed around the end of a reinforced hose over a stem that is inserted into the end of the hose. The stem may or may not have barbs that are meant to improve the “grip” between the hose and the end connector. Often, the outer layer of hose rubber is “skived” which means that the outer layer of rubber is removed exposing the reinforcement (although some local distributors do not skive).

The reinforced hose is actually held in the end connector by the ridges of the ferrule gripping the reinforcement via compression of the hose against the stem. The compression operation (swaging or crimping) of the ferrule against the reinforcement and against the inner stem creates severe stress and strain within the rubber of the hose and in particular the reinforcement.

It is known that multiple ply-reinforced hose may contain manufacturing defects (actually all reinforced hose may contain defects). During manufacture a ply, or a wire of cable forming the ply, may be out of position. That is, rather than lie next to each other a void (filled of course with rubber) may exist between the plys or the wire or cable forming the ply; the plys may be off-center; or, one or more cables may stand out (i.e., be slightly above the other cables). These defects can cause failure, if the defect is within or near the confines of the swaged or crimped connection.

The reason for the failure is relatively simple and relates back to stress imposed on the plys by the end connector. If a cable or ply is out of place, that element will be compressed more than the other elements. This additional compression puts more stress on the out-of-place reinforcement that can result in failure.

Development of high pressure swaged end connectors for rubber hose has extended over a period of years and the art runs the gauntlet from low temperature and/or low pressure to high temperature and/or high pressure applications. The hose diameters range from fractional inches (fractional centimeters) to tens of inches (fractional meters) and the manufacturers/providers of connectors realize that the pump-off force on the fitting is proportional to the inside diameter of the hose and the applied pressure.

As explained in U.S. Pat. No. 7,388,090 to Baldwin et at., which is incorporated in its entirety in this disclosure by reference, most of the standard prior art uses a serrated stem that has backward facing teeth that grips the inner liner of the hose to retain the stem in the hose. Further the art also uses a series of lands (ridges) within the ferrule that bite into the outer layer of the hose and the reinforcement and supposedly causes the teeth (or barbs) of the stem to bite further into the inner lining.

Baldwin et al. explain that the standard art causes severe failure of the reinforcing cable (or wire) because the sharp edges of the connector damage the reinforcement. In order to overcome this basic failure Baldwin et al. proposed an invention that consisted of a “waved” ferrule and stem that joins an end connector to flexible reinforced rubber hose thereby forming a “double sine-wave lock” between the ferrule and the stem, and thereby making certain that the axial tension is transferred to the ferrule from the reinforcement (see U.S. Pat. No. 7,388,090). The ferrule and stem are welded together at the coupling end leaving an opening, which accepts the reinforced rubber (elastomer) hose in almost the same manner as a normal “ridged” ferrule and “barbed” stem fitting. Rather than having straight sides, the lands of the ferrule and high points of the stem have a sinusoidal shape-wave. The wave pattern has the appearance of ripples on a pond caused by throwing a stone into the water.

The ‘double sine-wave lock’ invention locks all the plys of hose reinforcement inside the end connector, between the stem and ferrule, in a sine wave compressed against the ferrule and the stem to give the fitting an overall strength that is in excess of the strength of the free standing hose (without end connectors) whether or not the hose is under pressure, that is the connector and hose within the connector will not be the weak link. Grade E hose has a minimum burst pressure of 18,750 psi; thus the instant device, when used with grade E hose will have an overall strength greater than 18,750 psi. (At these pressures the pump-off forces involved reach or exceed 400,000 pounds_{force} depending on the cross sectional areas.) The invention carefully considers the material forming the ferrule and stem and the relative movement of those materials while attaching the end connector to the hose along with the unpredictable qualities of rubber and flexible hose construction to minimize induced stress in the hose reinforcement. All of these factors, including the sinusoidal shape of the ferrule and stem and the preferred two-step method of attachment (internal expansion of the stem followed by external swaging of the ferrule), operate together to form the original Baldwin et al. invention.

Baldwin et al. have recently filed an improvement to the original Baldwin et al. device wherein the first improved embodiment is a ferrule wherein all the flutes follow a modified (sine x)/x function in that the flutes go from a maximum height at the termination end of the connector to a minimum height at the hose end of the connector. The lands between the flutes are sloped or curved following a modified (sine x)/x function. The associated stem has a series of matching bumps that, when the swaging operation is complete, align within the center of the lands of the ferrule. Although the bumps have heights that vary from a maximum at the termination end of the connector to a minimum at the hose end of the connector, there is no true modified (sine x)/x that defines the bumps (unlike the original Baldwin et al. invention). The stem and ferrule are connected together by a suitable process, such as welding. The second embodiment is more complex and actually connects to the reinforcement.

The end connector of the second Baldwin et al. device is joined to the reinforced hose in the standard manner without first internally expanding the stem and which may involve skiving the outer jacket. The hose is carefully placed within the end connector cavity formed between the ferrule and the stem to the point where the end of the inner tube rests just past the last flute and within the last land at the termination end of the connector. The fitting is then preferentially swaged onto the hose using standard techniques.

As the swaging process occurs, the small bumps on the stem create and offset force which causes the reinforcing to expand into the lands of the ferrule forming the sine-wave lock between the reinforcement and the lands and flutes of the ferrule.

The stem may be coated, during manufacture or at any time, with a friction reducing material that allows the inner tube of the reinforced hose to more freely slide along the stem during the process that swages (or crimps) the connector to the hose. An expansion area for excess rubber and other ‘by-products’ of the swaging operation is provided at the termination end of the connector (i.e., between the ferrule and stem at the termination end of the connector).

Both Baldwin et al. devices have as one object the reduction of induced stress within the high pressure hose during the swaging operation, and are in fact very concerned with stress in the inner tube. If the inner tube is over stressed during the swaging operation there is a high probability that the inner tube will rip and fail under pressure, and the hose will leak about the end connector thus rendering the entire flexible hose system unusable. In addition, the API has toughened its temperature and flexibility (pulsation) standards for oil field hose (October 2006). Thus, there is needed a technique that will reinforce the inner tube so that the hose is more tolerant of stress, temperature and pulsation while still keeping the overall hose flexible.

### SUMMARY OF THE INVENTION

The invention modifies the standard method for manufacturing high pressure reinforced rubber hose by adding a thin un-vulcanized layer of inner tube rubber (or elastomer) on top of the first spiral wrapped layer of un-vulcanized inner tube rubber and then completing the buildup of the inner tube by spiral wrapping the required un-vulcanized layers.

The thin un-vulcanized layer is axially set in place over the first spiral wrapped layer. The thin un-vulcanized layer is reinforced with carbon fibre filaments. Thus, the carbon fibre filaments will lie axially within the completed inner tube. This axial reinforcement will meet the objective of keeping stresses induced in the inner tube during the swaging or crimping process from ripping the inner tube, thereby causing the inner tube fail within the end connector which in turn will cause the end connector to fail through leakage.

The remainder of the high pressure reinforced hose is built up using standard spiral wrapping, both rubber and reinforcement. Finally the whole assembly is vulcanized.

### BRIEF DESCRIPTION OF THE DRAWINGS

FIG. 1A represents a piece of rubber being pulled in the axial direction as shown by the Force arrows.

FIG. 1B shows a “nick” in the piece of rubber undergoing a pulling force. Note that the force required to break the piece of rubber with be much less that the force in FIG. 1 A which is tensioning the rubber.

FIG. 1C shows the effect that the “nick” and the pulling force have on the piece of rubber.

FIG. 2 shows a standard built-up hose mandrel. The figure indicates the first spiral wrap for the inner tube, then the axial (or longitudinal) reinforcement layer, followed by the remaining spiral wraps.

FIG. 3A is a cross-section of the inner tube showing the first spiral wrap.

FIG. 3B is a cross-section of the inner tube showing the first spiral wrap and the thin axially placed layer. This layer may axially overlap or may be carefully aligned so that each piece lies next to the other.

FIG. 3C shows the subsequent spiral wrapped inner tube layers over the first spiral wrapped layer and the thin reinforced layer. This figure is not to scale.

### DESCRIPTION OF THE PREFERRED EMBODIMENT

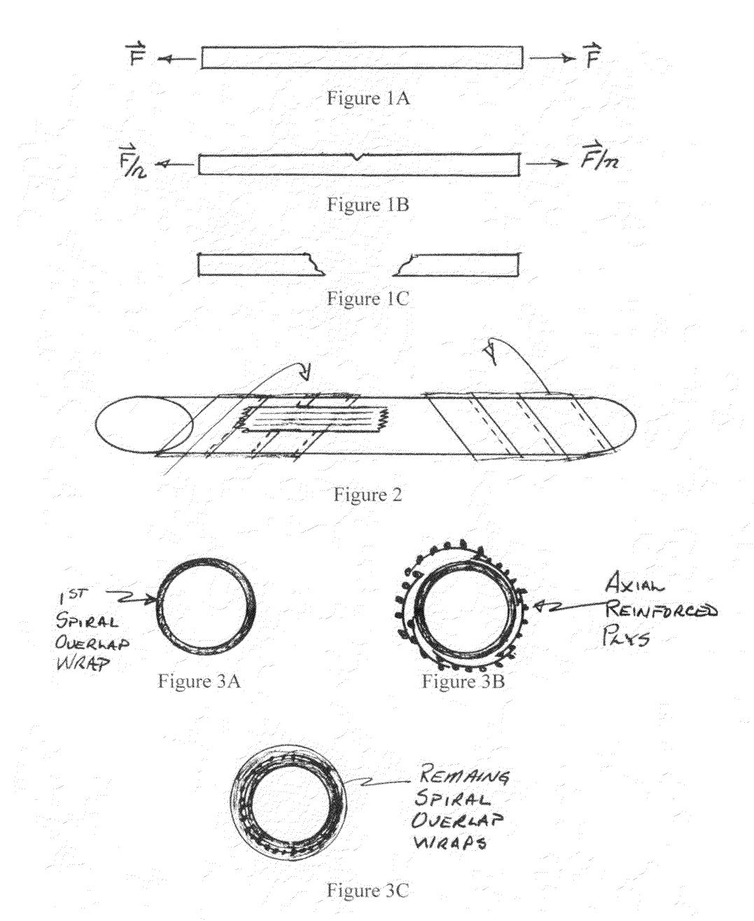

FIGS. 1A through 1C serve to illustrate the problem that this invention attempts to solve. It is well known that if a rubber band is stretched by applying a force to its ends, the band will elongate as shown in FIG. 1A. If a nick is placed in the band (as shown in FIG. 1B) or if there is a nick in band before it is stretched, then the band will break at the nick at substantially less elongation force. This results in two broken pieces of rubber as shown in FIG. 1C (actually the two pieces will, if the ends are allowed to come back to their un-extended state, meet up. But the rubber is broken.

A similar situation may exist within the inner tube of high pressure reinforced rubber hose particularly when a fitting is being swaged onto the hose. As outlined in the section of this disclosure entitled ‘Background of the Invention’ the material within the hose moves laterally within the end connector as the connector is being swaged onto the hose through the application of circumferential radial force on the connector.

All swage-type (or even crimp-type) end connectors employ a series of ridges, bumps, flutes, barbs, or etc. on the outside of the stem within the end connector. These structures, for lack of a better term, may act to ‘nick’ the inner tube during the swaging process or perhaps when the fitting is first placed on the hose prior to swaging. The Baldwin et al. devices discussed above attempt to remove any possibility that the inner tube could be nicked; however, the possibility still exists.

This invention attempts to reinforce the inner tube in a manner that has not been considered and in a manner that flies in face of hose manufacture. It is known that in order to obtain flexible hose the rubber layers and reinforcing must be spiral wrapped—that is to say the reinforcement cannot follow the axial or longitudinal axis of the hose. If the reinforce is axial, then the hose cannot bend. However, the forces on the inner tube that will cause failure of the inner tube run axially (or longitudinally).

FIG. 2 illustrates a mandrel used to manufacture flexible hose. The mandrel will have length between 60 and 120 feet depending on the manufacturer. (The longer mandrel is generally preferred because the resulting hose may be cut to a specified length—the custom hose as explained earlier in this disclosure.) A piece of uncured (un-vulcanized) rubber which is about five inches wide (this can vary depending on the hose and manufacturer) and roughly ¼-inch thick (this can vary depending on the hose and manufacturer) is spiral wrapped over the mandrel at roughly a 60-degree to the axial axis of the mandrel (hose). The rubber will overlap by one to two inches. A second layer will then be wrapped over the first layer forming an angle of about 60-degrees to the first layer. This process is repeated to a total of 4 layers and can be more or less depending on the hose and manufacturer. Following the inner tube, reinforcement (wire, cable, fibre, etc.) is spiral wrapped—no overlap—at a predetermined angle usually about 60 degrees to the axial axis of the mandrel (hose). The angles given above will vary from manufacturer to manufacturer and is dependent on the hose. The hose is then cured and removed from the mandrel.

This invention adds reinforcement to the inner tube. Pieces of uncured rubber (which are extremely tacky by nature) having the same properties as standard inner tube rubber are carefully prepared. This rubber comes from the manufacturer in 5-inch wide rolls that are separated by a backing material to which the rubber does not adhere. (The width can vary.) The thickness can be specified and is preferably 1/32-inch. These pieces are rolled out on preparation table, sticky side up and having a length equal to that of the mandrel. The number of pieces required is dependent of the circumference of the first inner tube layer. For example, in a four inch ID hose, the first inner tube layer—wrapped about the mandrel—will have a circumference of (4+2t)π, where t is the thickness of the first layer. {Assuming a thickness of ¼-inch, then the circumference would be 15.372 inches—which means that 4 pieces of rubber would easily surround the first inner tube layer. }

These pieces are carefully prepared by placing carbon fibre filaments on the surface which is sticky and would hold the fibres in place. The fibres should be spaced roughly ⅛ to ¼ inches apart.

As shown in FIG. 3A, the first spiral wound layer of inner tube rubber is placed on the mandrel. Then the 1/32-inch, specifically prepared reinforcing rubber is axially placed on the first inner tube layer as shown in FIG. 3B. Finally, the remaining spiral wound inner tube layers are placed on the mandrel as shown in FIG. 3C.

Note, it is possible to place the reinforcement inner tube rubber directly on the mandrel and then use overlapping spiral wound layers to complete the inner tube: this would be a manufacturing choice. The key to the invention is to place axial reinforcement as near to the bending center of the hose thereby minimizing the effect that the axial reinforcement could have on the overall bending radius.

It should be noted that the reinforcement in the inner tube must be designed so that the fluid pressure forces are transferred to the reinforcement of the actual built-up hose itself. Thus, although bias plys (like the actual wire, fabric or cable reinforcement is the hose) could be used, there would be a tendency for the inner tube to attempt to pick up the expansion force rather than transfer that force to the bias plys of the hose. Thus the inner tube reinforcement must be axial to the hose which will then allow the radial expansion force exerted by the high pressure fluid to be transferred.

Now consider a reinforcement fibre which is placed radially to the mandrel, or resulting hose. This position would be defined as a 90-degree bias. Bias, in the rubber industry, is defined as the angle between the longitudinal axis and the ply. It should be apparent that a 90-gree bias applied to the reinforcement of the inner tube would NOT act to prevent ripping and tearing of the inner tube during connection of the end connector to the hose. However, as the bias is reduced to zero the reinforcement would begin to act to prevent ripping and tearing. Thus, this disclosure anticipates that the inner tube reinforcement may have bias as stated in the claims. Further, as explained in the paragraph, it is anticipated that plys of reinforcement may be used, but these are really not preferred and any claim to such method or device would fall under the claims of this disclosure.

I claim:

1. A method of manufacture for reinforcing the inner tube of a reinforced high pressure flexible hose on a mandrel adapted for use in the manufacture of reinforced high pressure flexible hose comprising:
spiral wrapping a first layer of uncured inner tube elastomer about the mandrel,
preparing a plurality of thin strips of uncured inner tube elastomer having a top tacky side and bottom tacky side protected by a removable protection by:
laying out said strips tacky side up,
placing a plurality of reinforcement fibres longitudinally along said tacky side of said strips thereby forming a plurality of prepared strips,
axially placing said prepared strips over said first layer of uncured inner tube elastomer having removed said removable protection thereby forming a second layer,
spiral wrapping additional layers of uncured inner tube elastomer thereby completing the formation of the inner tube,
continuing the remaining standard manufacturing steps thereby forming the reinforced high pressure flexible rubber hose.

2. A method of manufacture for reinforcing the inner tube of a reinforced high pressure flexible hose comprising on a mandrel adapted for use in the manufacture of reinforced high pressure flexible hose comprising:
preparing a plurality of thin strips of uncured inner tube elastomer having a top tacky side and bottom tacky side protected by a removable protection by:
laying out said strips tacky side up,
placing a plurality of reinforcement fibres longitudinally along said tacky side of said strips thereby forming a plurality of prepared strips,
placing said prepared strips axially along the mandrel thereby forming a first layer of uncured inner tube,
spiral wrapping additional layers of uncured inner tube elastomer thereby completing the formation of the inner tube,
continuing the remaining standard manufacturing steps thereby forming the reinforced high pressure flexible rubber hose.

3. The method of manufacture of claim 1 wherein a second layer of spiral wrapped uncured inner tube elastomer is wrapped over said first layer and wherein said prepared strips are axially placed over said second layer.

4. The method of manufacture of claim 1 wherein a plurality of spiral wrapped uncured inner tube elastomer is wrapped about said mandrel followed by the axial placement of said prepared strips.

5. A reinforced inner tube for reinforced high pressure flexible rubber hose comprising a plurality of axial reinforcement fibres positioned within the inner tube during manufacture of the hose.

6. The method of manufacture of claims 1 through 4 wherein said prepared strips may have an angle to the axis thereby producing a bias to the reinforcement fibres within the inner tube.

7. The device of claim 5 wherein said axial reinforcement fibres may have a bias.
